(19) United States
(12) Patent Application Publication
(10) Pub. No.: US 2025/0382491 A1
(43) Pub. Date: Dec. 18, 2025

(54) AQUEOUS TOPCOAT COMPOSITION FOR DECORATIVE-FINISH FILMS

(71) Applicant: OSKAR NOLTE GMBH, Kirchlengern (DE)

(72) Inventor: Guido SCHWEIZER, Merklingen (DE)

(21) Appl. No.: 18/876,384

(22) PCT Filed: Jun. 23, 2023
(86) PCT No.: PCT/EP2023/067171

§ 371 Date: Dec. 18, 2024

(30) Foreign Application Priority Data
Jun. 24, 2022 (DE) 10 2022 115 834.9

(51) Int. Cl. C09D 133/06; C09D 11/03; C09D 175/04

(52) U.S. Cl. CPC C09D 133/066; C09D 11/03; C09D 175/04

(57) ABSTRACT

The invention relates to an aqueous topcoat composition for decorative-finish films containing 50 to 95 wt. % crosslinkable, OH-functional acrylic emulsion relative to the total weight of the topcoat composition, the aqueous topcoat composition being free of formaldehyde-based compounds. The invention also relates to a method for producing such an aqueous topcoat composition, a kit for producing a topcoat for decorative-finish films, a decorative-finish film, a method for producing a decorative-finish film, a decorative-finish film which is obtained or can be obtained by means of such a method, the use of a topcoat composition or a kit for producing a topcoat for a decorative-finish film, and the use of a decorative-finish film for coating wooden substrates (beams), edges and/or pieces of furniture.

The present invention relates to an aqueous topcoat composition for decorative-finish films, a method for producing such an aqueous topcoat composition, a kit for producing a topcoat for decorative-finish films, a decorative-finish film, a method for producing a decorative-finish film, a decorative-finish film which is obtained or can be obtained by means of such a method, the use of a topcoat composition or a kit for producing a topcoat for a decorative-finish film and the use of a decorative-finish film for coating wooden substrates (beams), edges and/or pieces of furniture.

Films are among the solid coating materials used for wood-based materials in furniture production, interior design and other areas. In this context, in particular thin sheet goods in the form of sheets or rolls made of metals, plastics or impregnated cellulose/pigment mixtures are referred to as films. During use, the films can have decorative as well as functional and protective properties, such as resistance to mechanical stresses.

Decorative-finish films are special printed or colored papers having a coated surface. The properties of decorative-finish films are determined by the carrier material, the printing and, in particular, the top coat. The carrier material, ink layer and coating layer components have an influence on the external appearance of the decorative-finish film and the properties and behavior of the film in further processing steps, for example when coating furniture.

Various coating systems are known from the state of the art that are used as top coats in the production of decorative-finish films. Acid-curing lacquers (SH lacquers) are two-component coating materials containing urea and melamine resins and an acidic hardener as a catalyst. They cure through a polycondensation reaction. The disadvantage of these systems is that the urea and melamine resins are formaldehyde-based and that formaldehyde is released during crosslinking. Formaldehyde can also be released from furniture coated with such lacquers. Formaldehyde is classified as toxic and carcinogenic and therefore poses a health risk.

Radiation-curing lacquers are cured by radiation, in particular ultraviolet radiation (so-called UV lacquers) or electron beams (so-called EBH lacquers). One example of such radiation-curing lacquers are monomeric acrylic acid compounds that cure with photoinitiators under UV radiation. The disadvantage of such radiation-curing systems is that special radiation-emitting devices and installations are required for curing, which are associated with additional costs and time. Such radiation-curing lacquers cannot be used on conventional machines for the production of decorative-finish films, in which crosslinking is carried out by thermal dryers.

The problem underlying the invention was therefore to provide an aqueous topcoat composition for decorative-finish films which at least partially overcomes one or more disadvantages of the prior art. Based on the prior art described above, one problem underlying the invention was to provide a topcoat composition which is less harmful to health, toxic and carcinogenic both before, during and after crosslinking. At the same time, the topcoat composition should be able to be used on conventional machines for the production of decorative-finish films. Furthermore, the topcoat composition should have good processing properties and, as a crosslinked topcoat of a decorative-finish film, should have good decorative properties as well as good functional and protective properties, such as good resistance to mechanical stresses.

A further problem underlying the present invention was to provide a decorative-finish film with good decorative as well as good functional and protective properties, such as good resistance to mechanical stresses. Such a decorative-finish film should also not release any compounds that are harmful to health after coating wooden substrates, edges and/or furniture.

All or some of these problems are solved according to the invention by an aqueous topcoat composition according to claim 1, a method according to claim 7, a kit according to claim 9, a decorative-finish film according to claim 11, a method according to claim 18, a decorative-finish film according to claim 23, a use according to claim 24 and a use according to claim 25.

Advantageous embodiments of the invention are given in the dependent claims and are explained in detail below.

The invention provides an aqueous topcoat composition for decorative-finish films comprising, based on the total weight of the topcoat composition, 50 to 95 wt. % of crosslinkable, OH-functional acrylic emulsion, wherein the aqueous topcoat composition is free of formaldehyde-based compounds.

Surprisingly, it has been shown that the aqueous topcoat composition for decorative-finish films according to the invention has good processing properties and can be used on conventional machines for the production of decorative-finish films. At the same time, the topcoat composition exhibits good decorative as well as good functional and protective properties, such as good resistance to mechanical stresses, after crosslinking. In addition, no irradiation is required to crosslink the topcoat composition and the topcoat composition has little or no hazardous properties. The latter can be attributed to the fact that the topcoat composition is free of formaldehyde-based compounds. Formaldehyde-based compounds are understood to mean, in particular, compounds in the manufacture of which formaldehyde is used. These include, in particular, melamine resins and urea resins.

OH-functional means that the acrylic emulsion has hydroxyl groups. These hydroxyl groups can preferably react with isocyanates, in particular polyisocyanates, and thus crosslink the crosslinkable, OH-functional acrylic emulsion.

The aqueous topcoat composition according to the invention contains, based on the total weight of the topcoat composition, 50 to 95 wt. % of crosslinkable, OH-functional acrylic emulsion. According to a preferred embodiment, the aqueous topcoat composition contains, based on the total weight of the topcoat composition, 60 to 90 wt. %, in particular 70 to 85 wt. % of crosslinkable, OH-functional acrylic emulsion.

The crosslinkable, OH-functional acrylic emulsion preferably has a solids content of from 20 to 70 wt. %, in particular from 30 to 60 wt. % or from 40 to 50 wt. %. Such a solids content of the OH-functional acrylic emulsion ensures particularly good processing properties of the aqueous topcoat composition.

Furthermore, the crosslinkable, OH-functional acrylic emulsion preferably has a viscosity, determined according to standard DIN EN ISO 3219, of 5 to 500 mPas, in particular of 10 to 100 mPas or of 15 to 40 mPas, at 23° C. and a shear rate of 100 s⁻¹. Such a viscosity of the OH-functional acrylic emulsion enables good processability of the aqueous topcoat composition.

In addition, the crosslinkable, OH-functional acrylic emulsion preferably has a minimum film-forming temperature of 30 to 220° C., in particular of 35 to 100° C. or of 40 to 70° C. A minimum film-forming temperature that is too high prevents a film from forming at the temperatures used in conventional machines for producing decorative-finish films.

Furthermore, the crosslinkable, OH-functional acrylic emulsion preferably has a glass transition temperature of 20 to 150° C., in particular of 30 to 110° C. or of 40 to 70° C.

Furthermore, the crosslinkable, OH-functional acrylic emulsion preferably has a hydroxyl number, in each case based on the solids content of the crosslinkable, OH-functional acrylic emulsion, of from 10 to 500 mg KOH/g, in particular from 30 to 300 mg KOH/g or from 50 to 150 mg KOH/g. Such a hydroxyl number enables uniform and sufficient crosslinking of the OH-functional acrylic emulsion and thus ensures good functional and protective properties, such as good resistance to mechanical stresses, by the topcoat.

Furthermore, the crosslinkable, OH-functional acrylic emulsion is preferably an OH-functional copolymer emulsion, in particular an OH-functional acrylic-methacrylic-styrene copolymer emulsion. It has been shown that such an OH-functional acrylic emulsion has particularly good processing properties and that top coats produced therefrom have particularly good functional and protective properties.

Finally, the crosslinkable, OH-functional acrylic emulsion is preferably crosslinkable with isocyanates, in particular with polyisocyanates, and a polyurethane is formed during crosslinking. The resulting crosslinked polyurethane topcoat has good decorative, functional and protective properties, such as good resistance to mechanical stresses.

According to a further preferred embodiment, the aqueous topcoat composition has a flow time at 23° C., determined using a flow cup with a nozzle diameter of 6 mm in accordance with standard ISO 2431, of 5 to 50 seconds, in particular of 11 to 22 seconds. Such a flow time ensures particularly good processing properties of the aqueous topcoat composition.

According to a further embodiment according to the invention, the aqueous topcoat composition has a pH of 5 to 11 at 25° C., in particular of 6 to 10 or of 7 to 9. A pH that is too high or too low poses a health risk when processing the aqueous topcoat composition. In addition, the topcoat cannot cure sufficiently and completely if the pH of the topcoat composition is too low.

Furthermore, the aqueous topcoat composition may preferably contain, based on the total weight of the topcoat composition, 0.1 to 20 wt. %, in particular 1 to 15 wt. % or 2 to 10 wt. % of additives.

In particular, the additives are wetting agents, dispersing agents, defoamers, leveling additives, rheology additives, matting agents, surface additives and/or additives to improve scratch resistance. Such additives improve the processing properties of the topcoat composition and/or the decorative, functional and/or protective properties of a topcoat produced therefrom.

Suitable wetting agents, dispersing agents, defoamers, surface additives and/or additives for improving the scratch resistance are known to the skilled person.

Suitable matting agents are, for example, amorphous silicate and/or wax dispersions, for example based on oxidized HDPE.

Finally, the aqueous topcoat composition may contain, based on the total weight of the topcoat composition, 0.1 to 10 wt. %, in particular 0.5 to 7.5 wt. % or 1 to 5 wt. % of film-forming aids. Suitable film-forming aids are esters such as 2,2,4-trimethyl-1,3-pentanediol monoisobutyrate, ether alcohols such as (di)ethylene glycol monobutyl ether and/or glycols such as ethanediol or propanediol.

According to a particularly preferred embodiment, the aqueous topcoat composition according to the invention contains, in each case based on the total weight of the aqueous topcoat composition, 70 to 85 wt. % of crosslinkable, OH-functional acrylic emulsion, 2 to 10 wt. % of additives, 1 to 5 wt. % of film-forming aid and water.

According to a further particularly preferred embodiment, the aqueous topcoat composition according to the invention consists of, in each case based on the total weight of the aqueous topcoat composition, 70 to 85 wt. % of crosslinkable, OH-functional acrylic emulsion, 2 to 10 wt. % of additives, 1 to 5 wt. % of film-forming aid and water.

The sum of all components of the aqueous topcoat composition according to the invention is 100 wt. %, based on the total weight of the aqueous topcoat composition. According to a preferred embodiment of the aqueous topcoat composition according to the invention, water makes up the missing components to 100 wt. %.

The invention further provides a method for preparing an aqueous topcoat composition according to the invention, comprising
i. Providing a crosslinkable, OH-functional acrylic emulsion, water and, if necessary, additives and/or film-binding aids,
ii. Mixing the crosslinkable, OH-functional acrylic emulsion, the water and optionally the additives and/or the film-binding aid, in a mixing ratio such that the aqueous topcoat composition obtained by mixing contains 50 to 95 wt. % of crosslinkable, OH-functional acrylic emulsion, based on the total weight of the aqueous topcoat composition.

What has been said in connection with the aqueous topcoat composition according to the invention with respect to the aqueous topcoat composition and/or the crosslinkable, OH-functional acrylic emulsion and/or the additives and/or the film-binding aid can also apply equally to the aqueous topcoat composition and/or the crosslinkable, OH-functional acrylic emulsion and/or the additives and/or the film-binding aid of the method according to the invention.

The invention also relates to a kit for producing a topcoat for decorative-finish films comprising a component 1 and a component 2, wherein component 1 is an aqueous topcoat composition according to the invention and component 2 is an aqueous hardener component, wherein the aqueous hardener component contains isocyanate, in particular polyisocyanate.

By mixing component 1 and component 2 of such a kit, subsequently applying the mixture to a carrier material and crosslinking, a decorative-finish film with good decorative as well as good functional and protective properties, such as good resistance to mechanical stresses, can be obtained.

Preferably, the aqueous hardener component contains isocyanate, in particular polyisocyanate, in an amount of 1 to 25 wt. %, in particular 5 to 20 wt. %, based on the total weight of component 2. Preferably, the polyisocyanate has an NCO content of 5 to 30 wt. %, in particular of 10 to 20 wt. %. Such a hardener component can cure the aqueous topcoat composition according to the invention and react with it to form a polyurethane topcoat layer which has good decorative as well as good functional and protective properties, such as good resistance to mechanical stresses. If the amount of isocyanate is too low and/or the NCO content is too low, curing is incomplete.

The invention also relates to a decorative-finish film comprising a carrier material and a topcoat layer, wherein the topcoat layer is a polyurethane layer which can be produced by crosslinking an aqueous topcoat composition according to the invention with an aqueous hardener component described above.

Such a decorative-finish film has good decorative, as well as good functional and protective properties, such as good resistance to mechanical stresses. Such a decorative-finish film can also be used to coat wooden substrates, edges and/or pieces of furniture and does not release any harmful compounds before and after coating.

The topcoat layer can be applied to the entire surface or partially to at least one side of the carrier material. If the topcoat layer is applied to the entire surface of the carrier material, the decorative-finish film has uniform and homogeneous surface properties. If the topcoat layer is partially applied to the carrier material, the decorative-finish film has a textured surface, which can be textured differently depending on the desired appearance and properties.

Various materials can be used as a carrier material for the decorative-finish film. Preferably, the carrier material is made of plastic and/or paper, in particular polyethylene terephthalate, polypropylene and/or paper. The carrier material is particularly preferably made of paper.

According to a preferred embodiment, the topcoat layer has a grammage of 3 to 15 mg/m², in particular of 4 to 12 g/m² or of 5 to 11 g/m². Such a grammage ensures the positive properties of the topcoat layer described above. If the grammage is too low, the decorative-finish film does not have the desired good functional and protective properties, such as good resistance to mechanical stresses. With a higher grammage, larger quantities of topcoat composition are required, making the decorative-finish film less resource-efficient and cost-effective.

The decorative-finish film can comprise an ink layer between the carrier material and the topcoat layer. Such an ink layer can be obtained in particular by printing the carrier material using flexographic printing, digital printing and/or gravure printing, in particular rotogravure printing. Such an ink layer provides the desired visual impression that is to be achieved with the decorative-finish film. Preferably, the ink layer contains binders, in particular protein binders, especially casein, and pigments. Suitable pigments for the ink layer of decorative-finish films are known to the skilled person.

According to a preferred embodiment, the decorative-finish film comprises a transparent primer layer between the ink layer and the topcoat layer, wherein the transparent primer layer is transparent to electromagnetic waves with wavelengths of 400 nm to 780 nm. Such a transparent primer layer can improve the adhesion of the topcoat layer to the ink layer, while at the same time maintaining the visual impression of the decorative-finish film achieved by the paint layer. It is particularly preferred that the transparent primer layer contains a crosslinked polyacrylate.

According to another preferred embodiment, the decorative-finish film comprises a pigmented primer layer between the carrier material and the topcoat layer. Such a pigmented primer layer can achieve a uniform and homogeneous color impression of the decorative-finish film and at the same time improve the adhesion between the carrier material and the topcoat layer. Preferably, the pigmented primer layer contains a crosslinked polyacrylate and pigments, in particular the pigmented primer layer contains pigments in an amount of 1 to 70 wt. %, in particular 2 to 60 wt. % or 5 to 40 wt. %, based on the total weight of the pigmented primer layer.

In a preferred embodiment, the decorative-finish film has the following layer structure from one side to the opposite side: carrier material, ink layer, optionally transparent primer layer, topcoat layer.

In another preferred embodiment, the decorative-finish film has the following layer structure from one side to the opposite side: carrier material, pigmented primer layer, topcoat layer.

According to a preferred embodiment, the decorative-finish film has a grammage of 25 to 100 g/m², in particular 45 to 82 g/m². Such a grammage ensures sufficient stability of the decorative-finish film and enables the coating of wooden substrates, edges and/or pieces of furniture with the decorative-finish film. If the grammage is too low, the decorative-finish film tears very easily during transportation. If the grammage is too high, larger quantities of materials are required, making the decorative-finish film less resource-efficient and cost-effective.

It is particularly preferable for the decorative-finishing film to be free of formaldehyde-based compounds. As a result, the decorative-finish film does not release any formaldehyde that is hazardous to health and does not have any properties that are hazardous to health.

The invention further provides a method for producing a decorative-finish film, comprising:
i. Providing a carrier material, an aqueous topcoat composition according to the invention and an aqueous hardener component,
ii. Mixing the aqueous topcoat composition and the aqueous hardener component,
iii. Applying the mixture prepared in step ii. to the carrier material,
iv. Crosslinking of the aqueous topcoat composition and the aqueous hardener component.

Such a method can be used to produce a decorative-finish film having the positive properties described above. In addition, the method can be used on conventional machines for the production of decorative-finish films.

The application in step iii. can be carried out using doctor blade dispensing systems, for example. In particular, the application can be carried out by roller coating.

What has been said above with respect to the decorative-finish film according to the invention, the carrier material and/or the aqueous hardener component can also apply equally to the decorative-finish film, the carrier material and/or the aqueous hardener component of the method according to the invention.

Preferably, the mixing in step ii. is carried out in a mixing ratio of aqueous topcoat composition to aqueous hardener component of from 20:1 to 1:1 by weight, in particular from 15:1 to 3:1 by weight or from 12:1 to 6:1 by weight. With a mixture prepared in this way, the crosslinking in step iv. can take place completely and uniformly.

Furthermore, the crosslinking in step iv. is preferably carried out at 80 to 250° C., in particular at 100 to 230° C. At such a temperature, crosslinking can take place quickly. A lower temperature prolongs the time required for crosslinking and is therefore less efficient. A higher temperature leads to increased energy consumption and is therefore less efficient.

The crosslinking in step iv. is preferably carried out in a thermal dryer, in particular a flotation dryer. Preferably, the crosslinking in step iv. is carried out without electron beam curing and without UV curing, in particular without radiation curing. The method can thus be used on conventional machines for producing decorative-finish films and, in particular, no special radiation-emitting devices and installations are required for the crosslinking.

The method according to the invention may comprise the following step before step iii:
a. Printing of the carrier material with an ink layer, wherein the printing is carried out in particular by flexographic printing, digital printing and/or gravure printing, in particular by rotogravure printing.

A decorative-finish film produced in this way can thus have the desired optical properties, in particular patterns and color shades.

The method according to the invention may further comprise the following steps:
b. Applying a primer composition to the carrier material, in particular wherein the primer composition comprises a crosslinkable polyacrylate, wherein the primer composition optionally comprises pigments,
c. Crosslinking the primer composition.

The preferred sequence of the method steps of the method according to the invention is: step i., step ii., optionally step a., optionally step b., optionally step c., step iii., step iv.

The method according to the invention can be carried out using an inline process. The method steps of printing the carrier material and applying the mixture of aqueous topcoat composition and aqueous hardener component are carried out in one and the same machine. For this purpose, a coating system can be installed at the end of a printing machine. Alternatively, the application of the mixture of aqueous topcoat composition and aqueous hardener component can be carried out offline in a separate coating unit.

The invention further provides a decorative-finish film obtained or obtainable by the method according to the invention.

In addition, it is an object of the invention to use an aqueous topcoat composition or kit according to the invention for producing a topcoat for decorative-finish films. This use enables the efficient production of a topcoat for decorative-finish films. The topcoat produced in this way has good functional and protective properties, such as good resistance to mechanical stresses.

Finally, it is an object of the invention to use a decorative-finish film according to the invention for coating wooden substrates, edges and/or pieces of furniture, in particular shelves. Wooden substrates, edges and/or pieces of furniture coated in this way then have the desired decor, in particular with regard to color design and feel, and are also well protected, for example against mechanical stresses such as abrasion and scratching.

The coating can be carried out in particular in flat presses, laminating systems or wrapping systems.

The principle of the invention will be explained in more detail below using examples that do not limit the subject-matter of the invention.

### EXAMPLES

### Example 1: Preparation of an Aqueous Topcoat Composition for Decorative-Finish Films

An aqueous topcoat composition was prepared by mixing the components shown in Table 1 at room temperature. The quantities are given in percent by weight, based on the total weight of the aqueous topcoat composition.

TABLE 1
Aqueous topcoat composition

| Component | Quantity [wt. %] |
|---|---|
| OH-functional acrylic-methacrylic- | 80 |
| styrene copolymer emulsion (45% | |
| solids by weight) | |
| Dispersing agent | 0.1 |
| Defoamer | 1 |
| Flow additive | 0.2 |
| Matting agent | 3 |
| Surface additive | 0.5 |
| Film-binding aid | 1 |
| Water | 14.2 |

### Example 2A: Preparation of a Decorative-Finish Film with Ink Layer and Transparent Primer Layer

The topcoat composition prepared in Example 1 was used to prepare a topcoat for a decorative-finish film.

For this purpose, 90 parts by weight of the aqueous topcoat composition from Example 1 were mixed with 10 parts by weight of an aqueous 10 wt. % polyisocyanate emulsion as hardener component.

The decorative-finish film was prepared using an inline process on a conventional printing machine with a coating unit installed at the end. Pre-impregnated decorative paper was printed using rotogravure printing with a water-based ink. A transparent primer composition was applied to the printed paper using a doctor roll. The subsequent crosslinking of the primer composition was started with a flotation dryer at a maximum temperature of 200° C. The mixture produced from the aqueous topcoat composition and hardener component was applied to the decor paper treated in this way by roller coating and crosslinked at a maximum temperature of 220° C. in a flotation dryer. The resulting decorative-finish film was then rolled up.

### Example 2B: Preparation of a Decorative-Finish Film with Pigmented Primer Layer

The topcoat composition prepared in Example 1 was used to prepare a topcoat for a decorative-finish film.

For this purpose, 90 parts by weight of the aqueous topcoat composition from Example 1 were mixed with 10 parts by weight of an aqueous 10 wt. % polyisocyanate emulsion as hardener component.

The decorative-finish film was produced using an inline process on a conventional printing machine with a coating unit installed at the end. A pigmented primer composition was applied to pre-impregnated paper using a doctor roll. The subsequent crosslinking of the primer composition was started with a flotation dryer at a maximum temperature of 200° C. The mixture produced from the aqueous topcoat composition and hardener component was applied to the decor paper treated in this way by roller coating and crosslinked at a maximum temperature of 220° C. in a flotation dryer. The resulting decorative-finish film was then rolled up.

### Example 3A: Coating a Wooden Substrate

The decorative-finish film prepared in Example 2A was applied to a wooden substrate using a wrapping machine. The wooden substrate then had the desired color impression printed on the paper, as well as the desired feel. The surface of the wooden substrate was also protected against mechanical stresses such as abrasion and scratching.

In addition, the decorative-finish film produced in Example 2A was applied to a wooden substrate using a laminating machine. The wooden substrate then had the desired color impression printed on the paper, as well as the desired feel. In addition, the surface of the wooden substrate was protected against mechanical stresses such as abrasion and scratching.

### Example 3B: Coating a Wooden Substrate

The decorative-finish film prepared in Example 2B was applied to a wooden substrate using a wrapping machine. The wooden substrate then had the desired uniform color impression and feel. The surface of the wooden substrate was also protected against mechanical stresses such as abrasion and scratching.

In addition, the decorative-finish film produced in Example 2B was applied to a wooden substrate using a laminating system. The wooden substrate then had the desired uniform color impression and feel. In addition, the surface of the wooden substrate was protected against mechanical stresses such as abrasion and scratching.

What is claimed is:

1. An aqueous topcoat composition for decorative-finish films, containing, based on the total weight of the topcoat composition, 50 to 95 wt. % of crosslinkable, OH-functional acrylic emulsion, wherein the aqueous topcoat composition is free of formaldehyde-based compounds.

2. The aqueous topcoat composition according to claim 1,
characterized in that the aqueous topcoat composition contains, based on the total weight of the topcoat composition, 60 to 90 wt. %, of crosslinkable, OH-functional acrylic emulsion.

3. The aqueous topcoat composition according to claim 1, characterized in that the crosslinkable, OH-functional acrylic emulsion has a solids content of from 20 to 70 wt. %, and
the crosslinkable, OH-functional acrylic emulsion at 23° C. and a shear rate of 100 s⁻¹ has a viscosity, determined in accordance with standard DIN EN ISO 3219, of 5 to 500 mPas, and
the crosslinkable, OH-functional acrylic emulsion has a minimum film-forming temperature of from 30 to 220° C., and
the crosslinkable, OH-functional acrylic emulsion has a glass transition temperature of from 20 to 150° C., and
the crosslinkable, OH-functional acrylic emulsion has a hydroxyl number, in each case based on the solids content of the crosslinkable, OH-functional acrylic emulsion; of from 10 to 500 mg KOH/g, and
the crosslinkable, OH-functional acrylic emulsion is an OH-functional copolymer emulsion and
the crosslinkable, OH-functional acrylic emulsion can be crosslinked with isocyanates and a polyurethane is formed during crosslinking.

4. (canceled)

5. The aqueous topcoat composition according to claim 1, characterized in that the aqueous topcoat composition contains, based on the total weight of the topcoat composition, 0.1 to 20 wt. %, the additives being wetting agents, dispersants, defoamers, levelling additives, rheology additives, matting agents, surface additives and/or additives for improving scratch resistance, and the aqueous topcoat composition contains, based on the total weight of the topcoat composition, 0.1 to 10 wt. % of film-forming aid, and wherein the aqueous topcoat composition has a flow time at 23° C., determined using a flow cup with a nozzle diameter of 6 mm according to standard ISO 2431, of from 5 to 50 seconds, and
the aqueous topcoat composition has a pH of 5 to 11 at 25° C.

6. (canceled)

7. A method for preparing an aqueous topcoat composition according to claim 1, comprising
i. Providing a crosslinkable, OH-functional acrylic emulsion, and water,
ii. Mixing the crosslinkable, OH-functional acrylic emulsion, the water and optionally additives, in a mixing ratio such that the aqueous topcoat composition obtained by mixing contains 50 to 95 wt. % of crosslinkable, OH-functional acrylic emulsion, based on the total weight of the aqueous topcoat composition.

8. (canceled)

9. A kit for preparing a topcoat for decorative-finish films comprising a component 1 and a component 2, characterized in that component 1 is an aqueous topcoat composition according to claim 1 and component 2 is an aqueous hardener component, wherein the aqueous hardener component contains isocyanate.

10. The kit according to claim 9, characterized in that the aqueous hardener component contains isocyanate in an amount of from 1 to 25 wt. % based on the total weight of the aqueous hardener component, and
the polyisocyanate has an NCO content of from 5 to 30 wt. %.

11. A decorative-finish film comprising a carrier material and a topcoat layer, wherein the topcoat layer is a polyurethane layer which is preparable by crosslinking an aqueous topcoat composition according to claim 1 with an aqueous hardener component according to claim 9.

12. The decorative-finish film according to claim 11, characterized in that the topcoat layer is applied over the entire surface or partially to at least one side of the carrier material, and
the topcoat layer has a grammage of 3 to 15 mg/m² and characterized in that the carrier material is made of plastic or paper and characterized in that the decorative-finish film comprises an ink layer between the carrier material and the topcoat layer, and
wherein the ink layer contains binders and pigments.

13. (canceled)

14. (canceled)

15. (canceled)

16. The decorative-finish film according to claim 8, characterized in that the decorative-finish film comprises a pigmented primer layer between the carrier material and the topcoat layer,
wherein the pigmented primer layer contains a crosslinked polyacrylate and pigments, and wherein the pigments are contained in the pigmented primer layer in an amount of from 1 to 70 wt. % based on the total weight of the pigmented primer layer.

17. The decorative-finish film according to claim 8, characterized in that the decorative-finish film has a grammage of 25 to 100 g/m² and
the decorative-finish film is free of formaldehyde-based compounds.

18. A method of preparing a decorative-finish film comprising
i. Providing a carrier material, an aqueous topcoat composition according to claim 1, and an aqueous hardener component,
ii. Mixing the aqueous topcoat composition and the aqueous hardener component,
iii. Applying the mixture prepared in step ii. to the carrier material,
iv. Crosslinking of the aqueous topcoat composition and the aqueous hardener component.

19. The method according to claim 18, characterized in that the decorative-finish film wherein the mixing in step ii. is carried out in a mixing ratio of aqueous topcoat composition to aqueous hardener component from 20:1 to 1:1 by weight and the crosslinking in step iv. is carried out at 80 to 250° C., and/or
the crosslinking in step iv. is carried out in a thermal dryer.

20. (canceled)

21. (canceled)

22. The method according to claim 12, characterized in that the method comprises the following step before step iii:
a. Printing of the carrier material with an ink layer, wherein the printing is carried out by flexographic printing, digital printing gravure printing, or combinations thereof;
and
the method comprises the following steps:
b. Applying a primer composition to the carrier material, in particular wherein the primer composition comprises a crosslinkable polyacrylate, and wherein the primer composition optionally comprises pigments,
c. Crosslinking the primer composition.

23. A decorative-finish film obtained or obtainable by a method according to claim 12.

24. Use of an aqueous topcoat composition according to claim 1 or a kit for the preparation of a topcoat for decorative-finish films according to claim 1 for the preparation of a topcoat for a decorative-finish film.

25. (canceled)

26. The aqueous topcoat composition according to claim 3, wherein the OH-functional copolymer emulsion is an OH-functional acrylic-methacrylic-styrene copolymer emulsion.

27. The decorative-finish film according to claim 12 wherein the binders contain casein.

28. The decorative-finish film according to claim 12 wherein the decorative-finish film comprises a transparent primer layer between the ink layer and the topcoat layer being transparent to electromagnetic waves with wavelengths of 400 nm to 780 nm.
